SEQUENCE LISTING (1 sequence)

SEQ ID NO: 1 - protein, 300 aa, Bacillus amyloliquefaciens
AATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

(19) United States
(12) Patent Application Publication
(10) Pub. No.: US 2019/0136157 A1
(43) Pub. Date: May 9, 2019

(54) ENZYME-CONTAINING DETERGENT OR CLEANING AGENT

(71) Applicant: Henkel AG & Co. KGaA, Duesseldorf (DE)

(72) Inventors: Susanne Wieland, Dormagen (DE); Nina Mussmann, Willich (DE); Christian Degering, Erkrath (DE); Michael Dreja, Neuss (DE); Brian Laufs, Juechen (DE)

(73) Assignee: Henkel AG & Co. KGaA, Duesseldorf (DE)

(21) Appl. No.: 16/184,541

(22) Filed: Nov. 8, 2018

(30) Foreign Application Priority Data
Nov. 9, 2017 (DE) 10 2017 219 993.8

(51) Int. Cl. C11D 3/386

(52) U.S. Cl. CPC C11D 3/38636; C11D 3/38645; C11D 3/38627; C11D 3/38663; C11D 3/38654

(57) ABSTRACT

The present disclosure relates to detergents or cleaning agents that comprise two enzyme-containing compositions A and B physically separated from one another, wherein composition A is liquid and comprises at least one protease, preferably at least one metalloprotease; and composition B comprises at least one enzyme different from the protease in the first enzyme-containing phase, and to a method for laundering textiles or for automatic dishwashing with use of this detergent/cleaning agent.

### CROSS-REFERENCE TO RELATED APPLICATION

This application claims priority to German Patent Application No. 10 2017 219 993.8, filed Nov. 9, 2017, which is incorporated herein by reference in its entirety.

### TECHNICAL FIELD

The present disclosure relates to detergents or cleaning agents that comprise two enzyme-containing compositions A and B physically separated from one another, wherein composition A is liquid and comprises at least one protease, preferably at least one metalloprotease; and composition B comprises at least one enzyme different from the protease in the first enzyme-containing phase, and to a method for laundering textiles or for automatic dishwashing with use of this detergent/cleaning agent.

### BACKGROUND

The most important factor both when laundering textiles and in the case of automatic dishwashing is the cleaning power over a wide range of different stains. In this regard, there is a general need for laundry and dishwashing detergents that have an increased cleaning power. In addition, a general trend of dispensing with phosphates for reasons of environmental protection is evident. The problem which arises is thus that of providing phosphate-free agents without detriment to the cleaning power or stability.

In order to be able to effectively remove stains, such agents generally require alkalinity. For many further stains, enzymes are required, for example analyses and proteases. There is the problem, however, that alkalinity and enzymes cannot be formulated together in a stable manner.

In liquid laundry and dishwashing detergents, special stabilisers are also necessary in order to stabilise the enzymes. These stabilisers include, inter alia, calcium salts and, particularly for proteases, additionally polyols and/or boric acid.

Due to the incompatibility of the conventional constituents, it is usual to formulate agents of this kind with different phases or in the form of a plurality of compositions physically separated from one another. Here, the enzymes are usually formulated in a manner separated from other constituents incompatible therewith, such as alkali sources, bleaches, or the like. Multi-phase formulations of this kind in the form of tabs or multi-chamber pouches are known both for automatic dishwashing detergents and laundry detergents.

There is the problem, however, that the enzymes contained in the enzyme-containing phase also often differ significantly with regard to their stability in respect of other constituents and their pH values. Although it is known to use enzyme variants that are optimised with regard to their stability, these enzyme variants are often adapted to alkaline pH values, or losses with regard to the cleaning power during the course of the stabilisation have to be accepted.

### BRIEF SUMMARY

A detergent or cleaning agent is provided herein. The agent includes two enzyme-containing compositions A and B physically separated from one another. Composition A is a liquid and includes at least one protease. Composition B includes at least one enzyme different from the protease in the first enzyme-containing composition A.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

The object of the present disclosure was therefore to provide a detergent or cleaning agent, preferably laundry or dishwashing detergent, which overcomes the aforementioned problems relating to stability and at the same time has a good cleaning power.

It has now been found that a stable and high-performing formulation can be provided if the enzymes contained therein are formulated in two compositions physically separated from one another, wherein the first composition contains a protease, preferably a metalloprotease, and the second composition comprises the other enzymes.

A first subject of the present disclosure is therefore a detergent or cleaning agent, exemplified in that the agent comprises two enzyme-containing compositions A and B physically separated from one another, wherein
(a) composition A is liquid and comprises at least one protease, preferably at least one metalloprotease; and
(b) composition B comprises at least one enzyme different from the protease in the first enzyme-containing phase.

In a further aspect, the present disclosure also relates to the use of multi-phase detergents or cleaning agents of this kind for the laundering of textiles or automatic cleaning of dishes.

Lastly, the present disclosure also relates to methods for the laundering of textiles or automatic cleaning of dishes, exemplified in that a detergent or cleaning agent as described herein is used in at least one method step.

These and further aspects, features and advantages of the present disclosure will become clear to a person skilled in the art from studying the following detailed description and claims. Here, any feature from one aspect of the present disclosure can be used in any other aspect of the present disclosure. It is also self-evident that the examples contained herein are intended to describe and clarify the present disclosure, but are not intended to limit the present disclosure, wherein in particular the present disclosure is not limited to these examples. All percentages, unless stated otherwise, are % by weight. Numerical ranges specified in the format “from x to y” include the stated values. If a plurality of preferred numerical ranges are specified in this format, it is self-evident that all ranges created by a combination of the various endpoints are also included.

The subject of the present disclosure includes all conceivable detergent or cleaning agent types, that is to say both concentrates and agents that are to be used in undiluted form, for use on a commercial scale, in washing machines or in hand washing or manual cleaning. For example, detergents for textiles, carpets or natural fibres are included, with the term “detergent” being used in this regard. For example, dishwashing detergents for automatic dishwashers or manual dishwashing detergents or cleaners for hard surfaces, such as metal, glass, porcelain, ceramic, tile, stone, lacquered surfaces, plastics materials, wood or leather, are also included, with the term “cleaning agent” being used in this regard, that is to say, in addition to manual and automatic dishwashing detergents, scouring agents, glass cleaners and WC fresheners, etc. are also included. The detergents and cleaning agents within the scope of the present disclosure also include auxiliary washing agents, which are added in a metered manner to the actual detergent in the case of manual or automatic textile laundering so as to attain a further effect. Furthermore, detergents and cleaning agents within the scope of the present disclosure also include textile pre- and post-treatment agents, that is to say agents with which an item of laundry can be brought into contact prior to the actual laundering, for example in order to dissolve stubborn stains, and also agents which in a step subsequent to the actual textile laundering provide the item(s) to be washed with further desirable properties, such as a pleasant feel, a lack of creasing, or low static charge. The latter agents are fabric softeners, inter alia.

Herein, the term “at least one” includes, but is not limited to 1, 2, 3, 4, 5, 6 and more. Based on an ingredient, the term relates to the kind of ingredient rather than to the absolute number of molecules. “At least one builder” thus means for example at least one kind of builder, that is to say that one kind of builder or a mixture of a plurality of different builders can be intended. Together with weight specifications, the term relates to all compounds of the given kind that are contained in the composition/mixture, i.e. the composition does not contain any further compounds of this kind beyond the specified amount of corresponding compounds.

If reference is made herein to molar masses, these values always relate to the number-average molar mass Mₙ, unless explicitly stated otherwise. The number-average molar mass can be determined for example by employing gel-permeation chromatography (GPC) in accordance with DIN 55672-1:2007-08 with THF as eluent. The weight-average molar mass M_{w} can likewise be determined by employing GPC, as described for Mₙ.

The terms “phosphate-free” and “phosphonate-free” as used herein mean that the composition in question is substantially free from phosphates or phosphonates respectively, i.e. in particular contains phosphates or phosphonates respectively in amounts less than about 0.1% by weight, preferably less than about 0.01% by weight, in relation to the corresponding composition.

As used herein, the term “liquid” includes liquids and gels and also pasty compositions. It is preferred that the liquid compositions are flowable and pourable at room temperature, however it is also possible that they have a yield point.

Since the agents of the present disclosure are partially low in water to anhydrous, the specified pH value in various embodiments relates to about 10% solution of the particular composition in distilled water at about 25° C. The term “low in water” relates to water contents of up to about 20% by weight, preferably up to about 15% by weight, even more preferably up to about 10% by weight, and the term “anhydrous” relates to water contents of up to about 5% by weight, in particular compositions in which water is not intentionally added, but at most is introduced with other constituents. The water content can be determined by employing Karl-Fischer titration.

The term “physically separated” in relation to the compositions, as used herein, means that the compositions do not come into contact with one another prior to use. The agent is usually provided for this purpose in a multi-chamber packaging, for example a bottle or a pouch, in particular a two-chamber bottle or a two-chamber pouch, wherein the composition in question is located in a separate chamber separately from the other composition(s).

Composition A preferably contains at least one metalloprotease.

The term “metalloprotease” is used herein in its conventional sense within the field of enzyme research and denotes a protease that requires a bound metal ion in order to be catalytically active. This is usually a zinc ion. The metalloproteases are preferably neutral metalloproteases, i.e. those that inter alia are active even at a neutral pH and require zinc ions for their catalytic effect. The molecular weight of proteases of this kind is usually in the range of from about 30 to about 40 kDa. The neutral metalloproteases are also referred to as “neutral metalloendopeptidases” and include enzymes in the class EC 3.4.24.4.

In various embodiments, the at least one metalloprotease is selected from metalloproteases from B. amyloliquefaciens and variants thereof, preferably a metalloprotease that comprises an amino acid sequence having at least about 80% sequence identity with the amino acid sequence specified in SEQ. ID NO: 1 over the entire length. In various embodiments, the amino acid sequence has at least about 81, about 82, 83, about 84, about 85, about 86, about 87, about 88, about 89, about 90, about 90.5, about 91, about 91.5, about 92, about 92.5, about 93, about 93.5, about 94, about 94.5, about 95, about 95.5, about 96, about 96.2, about 96.4, about 96.6, about 96.8, about 97.0, about 97.2, about 97.4, about 97.6, about 97.8, about 98.0, about 98.2, about 98.4, about 98.6, about 98.8, about 99.0, about 99.1, about 99.2, about 99.3, about 99.4, about 99.5, about 99.6, about 99.7, about 99.8, about 99.9 or about 100.0% sequence identity with the amino acid sequence specified in SEQ ID NO:1 over the entire length. In various embodiments the metalloprotease consists of a sequence of this kind, in particular from the sequence specified in SEQ ID NO: 1. In further embodiments, variants of these proteases that are N-terminally and/or C-terminally truncated or extended by from about 1 to about 50, for example from about 1 to about 30 amino acids and/or comprise insertions, substitutions or deletions compared to the above-described sequences are also included, wherein, however, the protease activity is maintained, and in particular is at least about 70% of the activity of the non-truncated/non-extended/non-mutated enzyme. The truncation or extension at one terminal or both termini is preferably in each case from about 1 to about 50 amino acids, in particular from about 1 to about 30, for example about 1, about 2, about 3, about 4, about 5, about 6, about 7, about 8, about 9, about 10, about 11, about 12, about 13, about 14, about 15, about 16, about 17, about 18, about 19, about 20 amino acids. An extension can be produced for example in that a signal peptide or a fragment of a signal peptide of this kind is located upstream N-terminally and was not cleaved or was not fully cleaved. A truncation can also be produced in that a cleaving of this kind generates further truncated by-products.

The identity of nucleic acid or amino acid sequences is determined by a sequence comparison. This sequence comparison is based on the BLAST algorithm established in the prior art and usually used (see for example S. F., Gish, W., Miller, W., Myers, E. W. & Lipman, D. J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, S. 3389-3402) and is implemented primarily in that similar sequences of nucleotides or amino acids in the nucleic acid or amino acid sequences are associated with one another. An association of the relevant positions in table form is referred to as alignment. A further algorithm available in the prior art is the FASTA algorithm. Sequence comparisons (alignments), in particular multiple sequence comparisons, are created using computer programs. For example, the Clustal series (see for example Chenna et al. (2003): Multiple sequence alignment with the Clustal series of programs. Nucleic Acid Research 31, 3497-3500), T-Coffee (see for example Notredame et al. (2000): T-Coffee: A novel method for multiple sequence alignments. J. Mol. Biol. 302, 205-217) or programs that are based on these programs or algorithms are often used. Sequence comparisons (alignments) with the computer program Vector NTI® Suite 10.3 (Invitrogen Corporation, 1600 Faraday Avenue, Carlsbad, Calif., USA) with the predefined standard parameters, the AlignX module of which for the sequence comparisons is based on ClustalW, are also possible. Unless stated otherwise, the sequence identity specified herein is determined using the BLAST algorithm.

A comparison of this kind also allows an assertion of the similarity of the compared sequences to one another. It is usually stated in percent identity, that is to say the proportion of identical nucleotides or amino acid groups at the same positions or positions corresponding to one another in an alignment. The broader term ‘homology’ in the case of amino acid sequences also takes preserved amino acid replacements into consideration, that is to say amino acids with similar chemical activity, since these usually exert similar chemical activities within the protein. The similarity of the compared sequences can therefore also be specified as percent homology or percent similarity. Identity and/or homology specifications can be provided for entire polypeptides or genes or only for individual regions. Homologues or identical regions of different nucleic acid or amino acid sequences are therefore defined by matches in the sequences. Such regions often have identical functions. They can be small and can comprise only a few nucleotides or amino acids. Small regions of this kind often perform essential functions for the overall activity of the protein. It can therefore be expedient to relate sequence matches only to individual, possibly small regions. Unless specified otherwise, however, identity or homology specifications in the present application relate to the total length of the nucleic acid or amino acid sequence specified in each case.

The protease is preferably a mature protease, i.e. the catalytically active molecule without signal and/or propeptide(s). Unless stated otherwise, the specified sequences also relate in each case to mature (processed) enzymes.

In various embodiments of the present disclosure the protease is a free enzyme. This means that the protease can act directly with all components of an agent and, since the composition is a liquid agent, that the protease is in direct contact with the solvent of the agent (for example water). In other embodiments, an agent can contain proteases that form an interaction complex with other molecules or contain a “casing”. Here, an individual protease molecule or a plurality of protease molecules can be separated from the other constituents of the agent by a surrounding structure. A separating structure of this kind can be produced by vesicles, such as micelle or a liposome, although it is not limited hereto. The surrounding structure, however, can also be a virus particle, a bacterial cell, or a eukaryotic cell.

Composition A contains the at least one protease preferably in an amount of active protein of from about 0.1 to about 50% by weight, preferably from about 0.1 to about 20% by weight, in relation to the total weight of the composition.

The protein concentration can be determined generally with the aid of known methods, for example the BCA method (bicinchoninic acid; 2,2′-biquinolyl-4,4′-dicarboxylic acid) or the Biuret method (A. G. Gornall, C. S. Bardawill and M. M. David, J. Biol. Chem., 177 (1948), p. 751-766). The active protein concentration can be determined in this regard via a titration of the active centres with use of a suitable irreversible inhibitor and determination of the residual activity (see M. Bender et al., J. Am. Chem. Soc. 88, 24 (1966), p. 5890-5913).

In various embodiments the enzyme-containing composition A contains at least one organic solvent, preferably selected from alcohols, particularly preferably liquid polyvalent alcohols that are polyvalent under standard conditions (about 20° C., 1013 mbar), in particular glycerol, 1,2-propanediol and sorbitol, and mixtures thereof. If these are contained, the amount is preferably from about 0.1 to about 99.9% by weight, more preferably from about 10 to about 90% by weight, in relation to the total weight of composition A.

In various embodiments it is preferred that the enzyme-containing composition A, in addition to the at least one protease, in particular metalloprotease, does not comprise any further enzymes, in particular no other proteases and/or amylases.

In various embodiments the enzyme-containing composition A contains at least one surfactant, preferably an alkoxylated alcohol, more preferably a fatty alcohol ethoxylate, preferably in an amount of from about 0.01 to about 10% by weight, particularly preferably from about 0.01 to about 5% by weight, in relation to the total weight of the composition. Decomposition can also contain at least one enzyme stabiliser and/or protease inhibitor, preferably in an amount of from about 0.1 to about 50% by weight, more preferably from about 0.1 to about 20% by weight, in relation to the total weight of the composition. All compounds known in the prior art for this purpose can be considered as potential stabilisers/inhibitors.

Polyols, in particular glycerol and 1,2-propylene glycol, benzamidine hydrochloride, borax, boric acids, boronic acids, or salts or esters thereof are established as reversible protease inhibitors in the prior art. Particularly good protection is provided if boric acid derivatives are used together with polyol, since these can then form a complex that stabilises the enzyme. Peptide aldehydes, that is to say oligopeptides with reduced C-terminus, in particular those formed of from about 2 to about 50 monomers, are also described for this purpose. Peptide-based reversible protease inhibitors include, inter alia, ovomucoid and leupeptin. Specific reversible peptide inhibitors and fusion proteins formed from proteases and specific peptide inhibitors are also used for this purpose.

Further established enzyme stabilisers are amino alcohols, such as mono-, di-, triethanol and -propanolamine and mixtures thereof, aliphatic carboxylic acids up to C₁₂, such as succinic acid, and other dicarboxylic acids or salts of the aforesaid acids. End-group-terminated fatty acid amide alkoxylates are also established for this purpose.

For example, water-soluble calcium salts, such as calcium chloride (CaCl₂)), calcium lactate, or calcium acetate and other salts of calcium with alpha-hydroxycarbonic acids or alpha-amino acids are also suitable as enzyme stabilisers, Organic (metal) salts such as formiates and acetates are also suitable.

The compounds of general structural formula

Z-A-(A)ₙ-NH—CH(R)—Y (I)

can also be used as enzyme stabilisers in various embodiments, wherein A is an amino acid group (preferred amino acid groups A are selected from Ala, Gly, Val, Ile, Leu, Phe, Lys); Y is —C(O)—X or CHOH—SO₃B, B is hydrogen or a suitable cation, in particular (alkali)metal cation, X is hydrogen or CF₃; Z is an N-capping group selected from phosphoramidate [(R′O)₂(O)P—], sulfenamide [(SR′)₂—], sulfonamide [(R′(O)₂S—], sulfonic acid [SO₃H], phosphinamide [(R′)₂(O)P—], sulfamoyl derivatives [R′O(O)₂S—], thiourea [(R′)₂N(O)C—], thiocarbamate [R′O(S)C—], phosphonate [R′—P(O)OH], amidophosphate [R′O(OH)(O)P—], carbamate (R′O(O)C—) and urea (R′NH(O)C—), wherein each R′ is selected independently from straight-chain or branched C1-C6 unsubstituted alkyl, phenyl, C7-C9 alkylaryl and cycloalkyl groups, wherein the cycloalkyl ring can be a C4-C8 cycloalkyl ring and can contain one or more heteroatoms selected from O, N, and S; R is selected from straight-chain or branched C1-C6 unsubstituted alkyl, phenyl and C7-C9 alkylaryl groups, in particular —CH₂-phenyl or —CH₂-(4-hydroxyphenyl); and n is 0, 1 or 2, preferably 0 or 1.

Preferred groups R are selected from methyl, iso-propyl, sec-butyl, iso-butyl, —C₆H₅, —CH₂—C₆H₅, —CH₂—C₆H₄OH (in particular CH₂-(4-hydroxyphenyl), and —CH₂—CH₂—C₆H₅, so that the portion —NH—CH(R)—Y of the compound of formula (I) is derived from the amino acids Ala, Val, Ile, Leu, Tyr, PGIy (phenylglycine), Phe, and HPhe (homophenylalanine) in that the carboxyl group is converted into an aldehyde or trifluoromethyl ketone group or an aldehyde hydrogen sulfite adduct. Although such groups are therefore not amino acids (although they may be synthesised from an amino acid precursor), in the case of the enzyme stabilisers listed herein by way of example the aldehyde part of the inhibitors derived from the corresponding amino acids is denoted, for the sake of simplicity, by the addition “H” after the analogous amino acid (for example “-AlaH” stands for the group “—NHCH(CH₃)C(O)H”). Trifluoromethyl ketones are exemplified similarly by the addition “CF₃” after the analogous amino acid (for example, “-AlaCF₃” stands for the group “—NHCH(CH₃)C(O)CF₃”). Lastly, the hydrogen sulfite adducts of aldehydes are denoted by the addition “SO₃H” or “SO₃Na” after the analogous amino acid (for example “-TyrSO₃H” stands for the group “—NHCH(CH₂C₆H₄OH)CHOH—SO₃H”).

The aldehydes of the present disclosure can be produced from the corresponding amino acids, wherein the C-terminal carboxyl group of the amino acid is converted into an aldehyde group. Aldehydes of this kind can be produced by employing known methods, as described for example in U.S. Pat. No. 5,015,627, EP 0 185 930, EP 0 583 534 and DE 3200812.

The trifluoromethyl ketones can also be produced from the corresponding amino acids in that the C-terminal carboxyl group is converted into a trifluoromethyl ketone group. Trifluoromethyl ketones of this kind can be produced by employing known methods, as described for example in EP 0 583 535.

The N-terminal end of the enzyme stabilisers is protected by a protective group which caps the N-terminus, wherein the group is selected from carbamates, ureas, sulphonamides, phosphonamides, thioureas, sulfenamides, sulfonic acids, phosphinamides, thiocarbamates, amidophosphates, and phosphonamides. In a preferred embodiment, however, the N-terminal end is protected by a methyl, ethyl or benzyl carbamate group [CH₃O—(O)C—; CH₃CH₂O—(O)C—; or C₆H₅CH₂O—(O)C—], a methyl, ethyl or benzyl urea group [CH₃NH—(O)C—; CH₃CH₂NH—(O)C—; or C₆H₅CH₂NH—(O)C—], a methyl, ethyl or benzyl sulfonamide group [CH₃SO₂—; CH₃CH₂SO₂—; or C₆H₅CH₂SO₂—], or a methyl, ethyl or benzylamidophosphate group [CH₃O(OH)(O)P—; CH₃CH₂O(OH)(O)P—; or C₆H₅CH₂O(OH)(O)P—].

The synthesis of the N-capping groups is known to a person skilled in the art.

Exemplary enzyme stabilisers that can be used as contemplated herein comprise, but are not limited to: CH₃O—(O)C-Leu-LeuH; CH₃O—(O)C-Ala-LeuH; CH₃CH₂O—(O)C-Ala-LeuH; C₆H₅CH₂O—(O)C-Ala-LeuH; CH₃O—(O)C-Ala-LeuCF₃; CH₃CH₂O—(O)C-Ala-LeuCF₃; C₆H₅CH₂O—(O)C-Ala-LeuCF₃; CH₃O—(O)C-Ala-IleH; CH₃CH₂O—(O)C-Ala-IleH; C₆H₅CH₂O—(O)C-Ala-IleH; CH₃O—(O)C-Ala-IleCF₃; CH₃CH₂O—(O)C-Ala-IleCF₃; C₆H₅CH₂O—(O)C-Ala-IleCF₃; CH₃O—(O)C-Gly-LeuH; CH₃CH₂O—(O)C-Gly-LeuH; C₆H₅CH₂O—(O)C-Gly-LeuH; CH₃O—(O)C-Gly-LeuCF₃; CH₃CH₂O—(O)C-Gly-LeuCF₃; C₆H₅CH₂O—(O)C-Gly-LeuCF₃; CH₃O—(O)C-Gly-IleH; CH₃CH₂O—(O)C-Gly-IleH; C₆H₅CH₂O—(O)C-Gly-IleH; CH₃O—(O)C-Gly-IleCF₃; CH₃CH₂O—(O)C-Gly-IleCF₃; C₆H₅CH₂O—(O)C-Gly-IleCF₃; CH₃NH—(O)C-Ala-LeuH; CH₃CH₂NH—(O)C-Ala-LeuH; C₆H₅CH₂NH—(O)C-Ala-LeuH; CH₃NH—(O)C-Ala-LeuCF₃; CH₃CH₂NH—(O)C-Ala-LeuCF₃; C₆H₅CH₂NH—(O)C-Ala-LeuCF₃; CH₃NH—(O)C-Ala-IleH; CH₃CH₂NH—(O)C-Ala-IleH; C₆H₅CH₂NH—(O)C-Ala-IleH; CH₃NH—(O)C-Ala-IleCF₃; CH₃CH₂NH—(O)C-Ala-IleCF₃; C₆H₅CH₂NH—(O)C-Ala-IleCF₃; CH₃NH—(O)C-Gly-LeuH; CH₃CH₂NH—(O)C-Gly-LeuH; C₆H₅CH₂NH—(O)C-Gly-LeuH; CH₃NH—(O)C-Gly-LeuCF₃; CH₃CH₂NH—(O)C-Gly-LeuCF₃; C₆H₅CH₂NH—(O)C-Gly-LeuCF₃; CH₃NH—(O)C-Gly-IleH; CH₃CH₂NH—(O)C-Gly-IleH; C₆H₅CH₂NH—(O)C-Gly-IleH; CH₃NH—(O)C-Gly-IleCF₃; CH₃CH₂NH—(O)C-Gly-IleCF₃; C₆H₅CH₂NH—(O)C-Gly-IleCF₃; CH₃SO₂-Ala-LeuH; CH₃CH₂SO₂-Ala-LeuH; C₆H₅CH₂SO₂-Ala-LeuH; CH₃SO₂-Ala-LeuCF₃; CH₃CH₂SO₂-Ala-LeuCF₃; C₆H₅CH₂S₂-Ala-LeuCF₃; CH₃SO₂-Ala-IleH; CH₃CH₂SO₂-Ala-IleH; C₆H₅CH₂SO₂-Ala-IleH; CH₃SO₂-Ala-IleCF₃; CH₃CH₂SO₂-Ala-IleCF₃; C₆H₅CH₂SO₂-Ala-IleCF₃; CH₃SO₂-Gly-LeuH; CH₃CH₂SO₂-Gly-LeuH; C₆H₅CH₂SO₂-Gly-LeuH; CH₃SO₂-Gly-LeuCF₃; CH₃CH₂SO₂-Gly-LeuCF₃; C₆H₅CH₂SO₂-Gly-LeuCF₃; CH₃SO₂-Gly-IleH; CH₃CH₂SO₂-Gly-IleH; C₆H₅CH₂SO₂-Gly-IleH; CH₃SO₂-Gly-IleCF₃; CH₃CH₂SO₂-Gly-IleCF₃; C₆H₅CH₂SO₂-Gly-IleCF₃; CH₃O(OH)(O)P-Ala-LeuH; CH₃CH₂O(OH)(O)P-Ala-LeuH; C₆H₅CH₂O(OH)(O)P-Ala-LeuH; CH₃O(OH)(O)P-Ala-LeuCF₃; CH₃CH₂O(OH)(O)P-Ala-LeuCF₃; C₆H₅CH₂O(OH)(O)P-Ala-LeuCF₃; CH₃O(OH)(O)P-Ala-IleH; CH₃CH₂O(OH)(O)P-Ala-IleH; C₆H₅CH₂O(OH)(O)P-Ala-IleH; CH₃O(OH)(O)P-Ala-IleCF₃; CH₃CH₂O(OH)(O)P-Ala-IleCF₃; C₆H₅CH₂O(OH)(O)P-Ala-IleCF₃; CH₃O(OH)(O)P-Gly-LeuH; CH₃CH₂O(OH)(O)P-Gly-LeuH; C₆H₅CH₂O(OH)(O)P-Gly-LeuH; CH₃O(OH)(O)P-Gly-LeuCF₃; CH₃CH₂O(OH)(O)P-Gly-LeuCF₃; C₆H₅CH₂O(OH)(O)P-Gly-LeuCF₃; CH₃O(OH)(O)P-Gly-IleH; CH₃CH₂O(OH)(O)P-Gly-IleH; C₆H₅CH₂O(OH)(O)P-Gly-IleH; CH₃O(OH)(O)P-Gly-IleCF₃; CH₃CH₂O(OH)(O)P-Gly-IleCF₃; C₆H₅CH₂O(OH)(O)P-Gly-IleCF₃; CH₃O—(O)C-Val-Ala-LeuSO₃Na; C₆H₅CH₂O—(O)C-Gly-Ala-TyrH; C₆H₅CH₂O—(O)C-Gly-Ala-TyrSO₃H; C₆H₅CH₂O—(O)C-Gly-Ala-TyrSO₃Na; C₆H₅O—(O)C-Gly-Ala-TyrSO₃H; and C₆H₅O—(O)C-Gly-Ala-TyrSO₃Na. In the above compounds the above-described terminology is used to identify the aldehyde and trifluoromethyl ketone groups.

In various embodiments the present disclosure also comprises all stereoisomers, in particular enantiomers and diastereomers, tautomers and salts of the above-described compounds.

Generally, the peptide derivatives and peptide adducts used as stabilisers can be selected from those that are described in patent publications WO 2013/004636 A1, WO 2014/173980 A2, WO 2013/004635 A1, WO2014/124927 A3, WO2009/118375 A2, U.S. Pat. No. 6,165,966 A and US2011/0039752 A1. Alternatively, phosphoramidon or galardin as described in CA2704311 A1 are suitable.

It is generally preferred that composition A contains the at least one protease and optionally enzyme stabilisers in amounts that are used typically in enzyme formulations as such, but not in enzyme-containing detergents and cleaning agents. The active protein content can therefore lie for example in the range of from about 1 to about 20% by weight, preferably in the range of from about 2 to about 15% by weight, or from about 5 to about 10% by weight. The amount of stabiliser is then adapted to the amount of enzyme and can also lie in the range of from about 1 to about 20% by weight.

In various embodiments, composition A can contain water as a solvent, however compositions that are low in water to anhydrous are also possible. In the latter case, the above-mentioned organic solvents are then used in particular.

It is preferable that the first enzyme-containing composition A does not contain any further constituents besides the at least one protease and optionally surfactant, enzyme stabiliser, solvent, salts and/or water. The salts can be in particular the salts mentioned above in the context of the stabilisers or also conventional alkali metal and alkaline earth metal salts, in particular halides, carbonates and/or sulfates. It is preferred that composition A does not contain any complexing agents, builders or chelators, in particular if the at least one protease is a metalloprotease.

It is also preferred that the pH value of composition A lies in the range of from about 5 to about 10, preferably in the range of from about 5.5 to about 9.5, even more preferably from about 6.5 to about 9.0, most preferably in the range of from about 7.0 to about 8.8.

Exemplary compositions A contain (in % by weight in relation to the total weight of the composition):

from about 0.1 to about 50% by weight, in particular from about 0.1 to about 20% by weight, of the at least one protease, in particular metalloprotease;
from about 0.1 to about 50% by weight, in particular from about 0.1 to about 20% by weight, of at least one enzyme stabiliser;
from about 0 to about 90% by weight, preferably from about 10 to about 90% by weight, of an organic solvent, in particular a polyvalent alcohol, such as in particular glycerol, 1,2-propanediol or sorbitol;
from about 0 to about 10% by weight of a surfactant, preferably an alkoxylate alcohol, more preferably a fatty alcohol ethoxylate; and
from about 0 to about 10% by weight of a salt.

The sum of the aforementioned constituents can add up here to about 100% by weight or can be supplemented with water to give about 100% by weight. The pH value of a composition of this kind preferably lies in the range of from about 5.5 to about 8. The composition is liquid or gel-like.

The enzyme contained in composition B and different from the protease and composition A can be selected from further proteases, amylases, lipases, cellulases, mannanases, hemicellulases, perhydrolases, oxidoreductases and combinations of a number thereof. In various embodiments composition B contains at least one amylase and/or at least one protease different from the protease contained in composition A. In further embodiments composition B also additionally contains at least one further enzyme. Suitable enzymes comprise, but are not limited to lipases, hemicellulases, in particular pectinases and/or mannanases, cellulases, perhydrolases or oxidoreductases, and preferably mixtures thereof. The proteases in composition B, if contained, preferably are not metalloproteases.

These enzymes are of natural origin in principle; proceeding from the natural molecules, variants that are improved for use in laundry and dishwashing detergents are made available and are used with preference accordingly.

The proteases used in composition B are in particular proteases of the subtilisin type (subtilases, subtilopeptidases, EC 3.4.21.62), which are serine proteases on account of the catalytically active amino acids. They act as non-specific endopeptidases and hydrolyse arbitrary acid-amide bonds present within peptides or proteins. Their pH optimum usually lies in the significantly alkaline range. An overview of this family is provided for example by the article “Subtilases: Subtilisin-like Proteases” by R. Siezen, pages 75-95 in “Subtilisin enzymes”, published by R. Bott and C. Betzel, New York, 1996. Subtilases are formed naturally by microorganisms. Mention should be made here in particular of the subtilisins formed and secreted by Bacillus species, these being the most significant group within the subtilases, and the optimised variants thereof known from the prior art. In various embodiments of the present disclosure, composition A does not contain any such proteases from the family of subtilisins or variants thereof, and instead only the above-described metalloproteases.

Examples of amylases that can be used as contemplated herein are the α-amylases from Bacillus licheniformis, from B. amyloliquefaciens, from B. stearothermophilus, from Aspergillus niger and A. oryzae and the developments of the aforementioned amylases improved for use in dishwashing detergents.

Lipases or cutinases can also be used as contemplated herein, in particular on account of their triglyceride-cleaving activities, but also in order to produce peracids from suitable precursors in situ. Examples include for example the lipases originally obtainable or developed from Humicola lanuginosa (Thermomyces lanuginosus).

Enzymes that are summarised under the term hemicellulases can also be used. These include mannanases, xanthanylases, pectinylases (=pectinases), pectinesterases, pectatylases, xyloglucanases (=xylanases), pullulanases and β-glucanases, for example.

In order to increase the bleaching effect, oxidoreductases can be used as contemplated herein, for example oxidases, oxygenases, catalases, peroxidases, such as halo, chloro, bromo, lignin, glucose or manganese peroxidases, dioxygenases or laccases (phenoloxidases, polyphenoloxidases). Preferably organic, particularly preferably aromatic compounds interacting with the enzymes are advantageously additionally added in order to intensify the activity of the oxidoreductases in question (enhancers) or in order to ensure the electron flow in the case of significantly different redox potentials between the oxidising enzymes and the stains (mediators).

Cleaning-active enzymes generally are not provided in the form of the pure protein, but rather in the form of stabilised preparations that are capable of being stored and transported. These prefabricated preparations for example include the solid preparations obtained by granulation, extrusion or lyophilisation or, in particular in the case of liquid or gel-like agents, solutions of the enzymes, advantageously preferably concentrated, with a low level of water and/or mixed with stabilisers or further auxiliaries. Composition A is preferably a prefabricated enzyme preparation of this kind.

Alternatively, the enzymes can be encapsulated both for the solid and liquid forms of administration, for example by spray drying or extrusion of the enzyme solution together with a preferably natural polymer or in the form of capsules, for example those in which the enzymes are enclosed in a solidified gel or in those of the core-shell type, in which an enzyme-containing core is coated with a protective layer impermeable to water, air and/or chemicals. Further active ingredients, for example stabilisers, emulsifiers, pigments, bleaching agents or dyes, can additionally be applied in the deposited layers. Capsules of this kind are produced by methods known per se, for example by shaking or rolling granulation or in fluid bed processes. Granular material of this kind is low in dust, for example by application of polymeric film formers, and is stable in storage on account of the coating.

It is also possible to manufacture two or more enzymes together, such that an individual granular material has a plurality of enzyme activities.

As is clear from the details provided above, the enzyme protein forms only a fraction of the total weight of conventional enzyme preparations. Enzyme preparations used with preference as contemplated herein contain between from about 0.1 and about 40% by weight, preferably between from about 0.2 and about 30% by weight, particularly preferably between from about 0.4 and about 20% by weight, and in particular between from about 0.8 and about 10% by weight of the enzyme protein.

Whereas the enzyme preparations for composition A are preferably used undiluted in the relatively high concentration, i.e. from about 0.1 to about 50% by weight, preferably from about 0.1 to about 20% by weight active protein, composition B can contain the enzyme preparations in concentrations that are conventional for laundry and dishwashing detergents, i.e. in an amount of from about 0.1 to about 12% by weight, preferably from about 0.2 to about 10% by weight, and in particular from about 0.5 to about 8% by weight enzyme preparations, in relation to the total weight. Here, it must be taken into consideration that these preparations again comprise the active protein only in the above-mentioned amount, such that the active protein concentration of the individual enzymes in composition B lies typically in the range of from about 10⁻⁵ to about 1% by weight.

A protein and/or enzyme can be particularly protected against damage during storage, for example inactivation, denaturing or decomposition, for example by physical influences, oxidation or proteolytic cleaving. With microbial extraction of the proteins and/or enzymes, an inhibition of proteolysis is particularly preferred, in particular if the agents also contain proteases.

For this purpose, the compositions B described herein can also contain the compounds disclosed above in context with composition A as stabilisers.

The use of calcium salt, polyols, boronic acids and/or peptide derivatives/adducts is particularly preferred, in particular a combination of calcium salt, in particular calcium chloride, and polyols, in particular sorbitol, with boronic acids, such as 4-FPBA, or with peptide adducts, such as those described above. The calcium salts are used here in the above-described amounts. The polyols are usually used in amounts of from about 5 to about 10% by weight in relation to the total weight of the composition, and the boronic acids/peptide adducts are usually used in amounts of up to about 1% by weight, typically up to about 0.1% by weight.

The laundry and dishwashing detergents described herein are preferably liquid in nature and can be present in particular in the form of homogeneous solutions or suspensions, i.e. both composition A and composition B and optionally all further provided compositions are present in liquid form. Alternatively, only compositions A and B can be provided in liquid form, and any further compositions are present in solid form. In this context, the term “solid” means that the composition is present under standard conditions in the form of a solid material, in particular in the form of powder or granules or a compacted material.

In a further preferred embodiment the detergent or cleaning agent, preferably laundry or dishwashing detergent, is provided in a pre-portioned form. The detergent or cleaning agent, preferably laundry or dishwashing detergent, comprises a plurality of compositions physically separated from one another, whereby on the one hand it is possible to separate incompatible ingredients from one another and on the other hand it is possible to offer compositions in combination which are used at different moments in time.

Further constituents of the detergents/cleaning agents as contemplated herein will be described hereinafter, wherein these constituents are contained preferably either in composition B or in a possibly provided further composition C or possibly provided further compositions C, D, etc., i.e. not in composition A. In one embodiment of the present disclosure, in addition to the compositions A and B, the detergents/cleaning agents of the present disclosure therefore contain at least one further composition C physically separated from said compositions A and B. It is generally preferred that the further constituents, in particular if they are insufficiently compatible with enzymes, are contained in an additionally provided further composition C, which is also physically separated from the compositions A and B.

The detergents or cleaning agents, preferably laundry or dishwashing detergents, can also contain at least one builder. Builders that can be used include in particular carbonates, citrates, phosphonates, organic builders, and silicates. The proportion by weight of the total builders in the total weight of detergent/cleaning agent as contemplated herein is for example from about 15 to about 80% by weight, even more preferably from about 20 to about 70% by weight, and in particular from about 30 to about 50% by weight.

Organic builders that are suitable as contemplated herein are for example the polycarboxylic acids (polycarboxylates) which can be used in the form of their sodium salts, wherein polycarboxylic acids are understood to mean carboxylic acids that carry more than one, in particular two to eight acid functions, preferably two to six, in particular two, three, four or five acid functions, in the molecule as a whole. Dicarboxylic acids, tricarboxylic acids, tetracarboxylic acids and pentacarboxylic acids, in particular di-, tri- and tetracarboxylic acids, are preferred as polycarboxylic acids. Here, the polycarboxylic acids can also carry further functional groups, such as hydroxyl or amino groups. For example, these are citric acid, adipic acid, succinic acid, glutaric acid, malic acid, tartaric acid, maleic acid, fumaric acid, sugar acids (preferably aldaric acids, for example galactaric acid and glucaric acid), aminocarboxylic acids, in particular aminodicarboxylic acids, aminotricarboxylic acids, aminotetracarboxylic acids, such as nitrilotriacetic acid (NTA), methylglycine diacetic acid (MGDA), glutamine-N,N-diacetic acid (also referred to as N,N-bis(carboxymethyl)-L-glutaminic acid or GLDA), aspartic acid diacetate (ASDA), hydroxyethyliminodiacetate (HEIDA), iminodisuccinate (IDS) and ethylenediaminedisuccinic acid (EDDS), and derivatives and mixtures thereof. Preferred salts are the salts of the polycarboxylic acids such as citric acid, adipic acid, succinic acid, glutaric acid, tartaric acid, MGDA and mixtures thereof.

Polymeric polycarboxylates (organic polymers with multiple (in particular more than ten) carboxylate functions in the macromolecule), polyaspartates, polyacetals and dextrins are also suitable as organic builders.

Besides their builder effect, the free acids typically also have the property of an acidifying component and can thus also be used to adjust the pH value. In particular, reference is made here to citric acid, succinic acid, glutaric acid, adipic acid, gluconic acid and any mixtures thereof.

Detergents/cleaning agents as contemplated herein can also contain, as builder, crystalline layered silicates of general formula NaMSiₓO₂ₓ₊.y H₂O, in which M is sodium or hydrogen, x is a number from about 1.9 to about 22, preferably from about 1.9 to about 4, wherein particularly preferred values for x are 2, 3 or 4, and y stands for a number from about 0 to about 33, preferably from about 0 to about 20. Amorphous sodium silicates with a modulus Na₂O:SiO₂ of from about 1:2 to about 1:3.3, preferably from about 1:2 to about 1:2.8, and in particular from about 1:2 to about 1:2.6, preferably with delayed dissolution and having secondary washing properties also can be used. In preferred cleaning agents as contemplated herein, in particular dishwashing detergents, preferably automatic dishwashing detergents, the content of silicates, in relation to the total weight of the cleaning agent, is limited to the amounts below about 10% by weight, preferably below about 5% by weight, and in particular below about 2% by weight. It is particularly preferred that the detergents/agents are free from silicates, wherein “free” in this context means that the amount is limited to less than about 0.1% by weight.

In various embodiments laundry or dishwashing detergents as contemplated herein contain, as one of their fundamental builders, one or more salts of citric acid, that is to say citrates. In various embodiments composition A does not contain any citrate.

The use of carbonate(s) and/or hydrogen carbonate(s), preferably alkali carbonate(s), particularly preferably sodium carbonate (soda) is likewise preferred. In various embodiments composition A does not contain any carbonate/hydrogen carbonate.

In addition to the aforementioned builders, the laundry or dishwashing detergents as contemplated herein, in particular dishwashing detergents, can also contain alkali metal hydroxides as alkali source, in particular in composition B or more preferably C. These alkali carriers are used in the detergents/cleaning agents and in particular in the second phase (composition B) preferably only in small amounts, preferably in amounts less than about 10% by weight, preferably less than about 6% by weight, preferably less than about 5% by weight, particularly preferably between from about 0.1 and about 5% by weight, and in particular between from about 0.5 and about 5% by weight, in each case in relation to the total weight of the composition. It is preferred, however, that the dishwashing detergents contain only small amounts of NaOH, and preferably are free from NaOH. In various embodiments of the present disclosure composition A therefore contains, in relation to the total weight of composition A, less than about 1.05% by weight of NaOH, preferably less than about 0.5% by weight NaOH, with composition A even more preferably being free from NaOH. In various embodiments of the present disclosure composition A is free from alkali sources. In various further embodiments composition B contains, in relation to the total weight of composition B, less than about 1.71% by weight NaOH, preferably less than about 1.0% by weight NaOH, with composition B even more preferably being free from NaOH. In various embodiments composition B, instead of NaOH, contains potassium hydroxide (KOH) as alkali source, preferably in the above-mentioned amounts, in particular up to about 3.5% by weight. In particular, the alkali metal hydroxides, particularly KOH, are used in such amounts that the desired pH values of the compositions are achieved.

The detergents or cleaning agents also preferably contain at least one surfactant. Here, the surfactants can be contained either in composition A or in composition B, or both. Surfactants to be used with preference in composition A have already been described above and will be described hereinafter in greater detail. The additional surfactants that will be described hereinafter can be contained in composition A, but are preferably contained in composition B or a further composition C. The surfactants described hereinafter are in particular those that are used in dishwashing detergents, in particular in automatic dishwashing detergents. If used, the detergents/cleaning agents are preferably dishwashing detergents. Alternatively, however, surfactants as are used primarily in laundry detergents can also be used, in particular the anionic surfactants and fatty alcohol alkoxylates described hereinafter. If these are used, the detergents/cleaning agents are preferably laundry detergents.

The surfactants contained preferably comprise non-ionic surfactants. All non-ionic surfactants known to a person skilled in the art can be used as non-ionic surfactants. Non-ionic surfactants that have weak foaming properties are preferably used at least in automatic dishwashing agents, in particular alkoxylated, especially ethoxylated non-ionic surfactants that have weak foaming properties. The automatic dishwashing detergents particularly preferably contain non-ionic surfactants from the group of alkoxylated alcohols. Surfactants that can be used with preference originate from the groups of alkoxylated non-ionic surfactants, in particular the ethoxylated primary alcohols and mixtures of these surfactants with surfactants of complex structure, such as polyoxypropylene/polyoxyethylene/polyoxypropylene ((PO/EO/PO) surfactants). Such (PO/EO/PO) non-ionic surfactants are additionally exemplified by good foam control.

The detergents/cleaning agents as contemplated herein, in particular dishwashing detergents, can also contain at least one sulfopolymer. The proportion by weight of the sulfopolymer in the total weight of the composition containing said sulfopolymer, preferably B or C, is preferably from about 0.1 to about 20% by weight, in particular from about 0.5 to about 15% by weight, particularly preferably from about 1.0 to about 10% by weight, in particular from about 2 to about 8% by weight, particularly from about 3 to about 6% by weight. Compositions that contain up to about 6% by weight sulfopolymer are very particularly preferred. The sulfopolymer is usually used in the form of an aqueous solution, wherein the aqueous solutions typically contain from about 20 to about 70% by weight, in particular from about 30 to about 50% by weight, preferably approximately 35 to about 40% by weight sulfopolymers.

A copolymer polysulfonate is preferably used as sulfopolymer, preferably a hydrophobically modified copolymer polysulfonate.

Depending on the desired purpose, the detergents/cleaning agents as contemplated herein preferably contain at least one further constituent, preferably selected from the group including of anionic, cationic and amphoteric surfactants, in particular anionic surfactants, bleaching agents, bleaching activators, bleaching catalysts, thickening agents, sequester agents, electrolytes, corrosion inhibitors, in particular silver protectants, grass corrosion inhibitors, foam inhibitors, dyes, fragrances, bitter substances and antimicrobial active ingredients.

Preferred anionic surfactants are fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates and lignin sulfonates. Fatty acid cyanamides, sulfosuccinates (sulfosuccinic acid esters), in particular sulfosuccinic acid mono- and -di-C₈-C₁₈-alkyl esters, sulfosuccinates, sulfosuccinamides, fatty acid iesthionates, acylaminoalkane sulfonates (fatty acid taurides), fatty acid sarcosinates, ethercarboxylic acids and alkyl(ether)phosphates and α-sulfo fatty acid salts, acyl glutamates, monoglyceride disulfates and alkyl ethers of glycerol disulfate can also be used within the scope of the present disclosure.

The anionic surfactants are preferably used as sodium salts, but may also be present as other alkali or alkaline earth metal salts, for example potassium or magnesium salts, as well as in the form of ammonium or mono-, di-, tri- or tetraalkylammonium salts, also in the form of their corresponding acid, for example dodecylbenzene sulfonic acid, in the case of sulfonates.

Suitable amphoteric surfactants include for example betaines of formula (Rⁱⁱⁱ)(R^{iv})(R^{v})N⁺CH₂COO⁻, in which Rⁱⁱⁱ means an alkyl group with from about 8 to about 25, preferably from about 10 to about 21 carbon atoms, optionally interrupted by heteroatoms or heteroatom groups, and R^{iv} and R^{v} mean the same or different alkyl groups with from about 1 to about 3 carbon atoms, in particular C₁₀-C₁₈-alkyl-dimethylcarboxymethylbetaine and C₁₁-C₁₇-alkylamidopropyl-dimethylcarboxymethylbetaine.

Suitable cationic surfactants are, inter alia, the quaternary ammonium compounds of formula (R^{vi})(R^{vii})(R^{viii})(R^{ix})N⁺X⁻, in which R^{vi} to R^{ix} stand for four of the same or different, in particular two long-chain and two short-chain alkyl groups and X⁻ stands for an anion, in particular a halide ion, for example didecyl-dimethyl-ammonium chloride, alkyl-benzyl-didecyl-ammonium chloride and mixtures thereof. Further suitable cationic surfactants are the quaternary surface-active compounds, in particular with a sulfonium, phosphonium, iodonium or arsonium group, which are also known as antimicrobial active ingredients. By using quaternary surface-active compounds with an antimicrobial effect, the detergent/cleaning agent can be embodied with an antimicrobial effect, or its antimicrobial effect, which is optionally already present on the basis of other ingredients, can be improved.

Advantageous ingredients of detergents/cleaning agents as contemplated herein are also disclosed for example in international patent application WO2009/121725, starting on page 5, penultimate paragraph, and ending on page 13, after the second paragraph. Express reference is made to that disclosure, and the content there is incorporated in the present patent application.

The pH value of the compositions can be adjusted generally by employing conventional pH regulators. In various embodiments the pH value of composition A lies in a range of from about 5.5 to about 8.5, preferably from about 6.5 to about 8.0, particularly preferably from about 7.0 to about 7.5, in particular is approximately 7.5, and the pH value of composition B lies in a range of from about 7.0 to about 12, preferably from about 8.0 to about 11.5, preferably above about 8, in particular from about 8.5 to about 11.5. Acids and/or alkalis, preferably alkalis, are used as pH adjusters. Suitable acids are in particular organic acids, such as acetic acid, citric acid, glycolic acid, lactic acid, succinic acid, adipic acid, malic acid, tartaric acid and gluconic acid, or also amidosulfonic acid. However, the mineral acids constituted by hydrochloric acid, sulfuric acid and salpetic acid or mixtures thereof can also be used. Suitable bases originate from the group of alkali and alkaline earth metal hydroxides and carbonates, in particular the alkali metal hydroxides, with potassium hydroxide being preferred. The above-described alkali source is particularly preferably used in order to adjust the pH value. Although volatile alkali, for example in the form of ammonia and/or alkanolamines, which can contain up to about 9 C atoms in the molecule, can be used in order to adjust the pH value, wherein the alkanolamine can be selected here from the group including of mono-, di-, triethanol- and -propanolamine and mixtures thereof, volatile alkali sources of this kind, in particular ethanolamines, are preferably omitted. In various embodiments the compositions therefore contain less than about 1.75% by weight alkanolamine, in particular monoethanolamine, and are very particularly preferably free therefrom. It has been found that the omission of alkanolamines of this kind increases the stability of the compositions.

As used herein in conjunction with a numerical value, the term “approximately” means the numerical value ±5%. “Approximately 7.5” therefore means from about 7.125 to about 7.875.

In order to adjust and/or stabilise the pH value, the detergent/cleaning agent as contemplated herein can contain one or more buffer substances (INCA buffering agents), usually in amounts of from about 0.001 to about 5% by weight. Buffer substances which at the same time are complexing agents or even chelating agents (chelators, INCI chelating agents) are preferred. Particularly preferred buffer substances are citric acid or citrates, in particular sodium and potassium citrates, for example trisodium citrate 2H₂O and tripotassium citrate H₂O.

The detergents/cleaning agents described herein can be presented in different ways. The liquid presentation form based on water and/or organic solvents can be present in thickened form, in the form of gels.

In various embodiments the detergent/cleaning agent or the corresponding liquid composition, directly after production, has a viscosity above about 2000 mPas (Brookfield Viscometer DV-II+Pro, spindle 25, 30 rpm, 20° C.), in particular between from about 2000 and about 10000 mPas.

The detergents and cleaning agents described herein are preferably prefabricated in the form of dosing units. These dosing units preferably comprise the amount of washing- or cleaning-active substances necessary for a cleaning process. Preferred dosing units have a weight between from about 12 and about 30 g. The volume of the aforementioned dosing units and the three-dimensional form thereof are preferably selected such that dosing of the prefabricated units via the dosing chamber of a washing machine or dishwasher is ensured. The volume of the dosing unit is therefore preferably between from about 10 and about 35 ml, preferably between from about 12 and about 30 ml.

The detergents and cleaning agents, in particular the prefabricated dosing units, particularly preferably have a water-soluble casing.

The water-soluble casing is preferably formed from a water-soluble film material, which is selected from the group including of polymers or polymer mixtures. The casing can be formed from one or two or more layers made of the water-soluble film material. The water-soluble film material of the first layer and the further layers, if present, can be the same or different. Films that for example can be glued and/or sealed to form packaged units, such as tubes or pods, once they have been filled with a detergent/cleaning agent are particularly preferred. In various embodiments the films have the form of multi-chamber pouches, wherein the compositions A and B are present physically separated in different chambers of a pouch made of a water-soluble film.

It is preferred that the water-soluble casing contains polyvinyl alcohol or a polyvinyl alcohol copolymer. Water-soluble casings that contain polyvinyl alcohol or a polyvinyl alcohol copolymer have good stability alongside sufficiently high water-solubility, in particular cold water-solubility.

Suitable water-soluble films for producing the water-soluble casing are preferably based on a polyvinyl alcohol or a polyvinyl alcohol copolymer of which the molecular weight lies in the range of from about 10,000 to about 1,000,000 gmol⁻¹, preferably from about 20,000 to about 500,000 gmol⁻¹, particularly preferably from about 30,000 to about 100,000 gmol⁻¹, and in particular from about 40,000 to about 80,000 gmol⁻¹.

Polyvinyl alcohol is usually produced by hydrolysis of polyvinyl acetate, because the direct synthesis pathway is impossible. The situation is similar for polyvinyl alcohol copolymers, which are produced from polyvinyl acetate copolymers accordingly. It is preferable if at least one layer of the water-soluble casing comprises a polyvinyl alcohol of which the degree of hydrolysis constitutes from about 70 to about 100 mol %, preferably from about 80 to about 90 mol %, particularly preferably from about 81 to about 89 mol %, and in particular from about 82 to about 88 mol %.

A polymer selected from the group comprising (meth)acrylic acid-containing (co)polymers, polyacrylamides, oxazolin polymers, polystyrene sulfonates, polyurethanes, polyesters, polyethers, polylactic acid or mixtures of the above polymers can additionally be added to a polyvinyl alcohol-containing film material suitable for producing the water-soluble casing. Polylactic acids constitute preferred additional polymers.

Preferred polyvinyl alcohol copolymers, in addition to vinyl alcohol, also comprise dicarboxylic acids as further monomers. Suitable dicarboxylic acids are itaconic acid, malonic acid, succinic acid and mixtures thereof, wherein itaconic acid is preferred.

Polyvinyl alcohol copolymers that are likewise preferred comprise, besides vinyl alcohol, an ethylenically unsaturated carboxylic acid, and the salt or ester thereof. Such polyvinyl alcohol copolymers, besides vinyl alcohol, particularly preferably also contain acrylic acid, methacrylic acid, acrylic acid ester, methacrylic acid ester, or mixtures thereof.

It may be preferable for the film material to contain additional additives. The film material may contain, for example, plasticisers such as dipropylene glycol, ethylene glycol, diethylene glycol, propylene glycol, glycerol, sorbitol, mannitol or mixtures thereof. Additional additives comprise, for example, release aids, fillers, crosslinking agents, surfactants, antioxidants, UV absorbers, antiblocking agents, antisticking agents or mixtures thereof.

Suitable water-soluble films for use in the water-soluble casings of the water-soluble packagings as contemplated herein are films distributed by the company MonoSol LLC, for example, under the designation M8630, C8400 or M8900. Other suitable films comprise films with the designation Solublon® PT, Solublon® GA, Solublon® KC or Solublon® KL from Aicello Chemical Europe GmbH or the films VF-HP from Kuraray.

The corresponding use of the detergents/cleaning agents as contemplated herein likewise forms part of the subject of the present disclosure.

A further subject of the present disclosure is a method for cleaning textiles or hard surfaces which is exemplified in that a detergent/cleaning agent as contemplated herein is used in at least one method step. The subject of the present application is thus in particular also a method for laundering textiles in an automatic washing machine or for cleaning dishes in a dishwasher, in which the detergent/cleaning agent as contemplated herein is introduced in a metered manner into the interior of a washing machine or dishwasher as a laundering or dishwashing program is running, prior to the onset of the main rinsing step or during the course of the main rinsing step. The detergent/cleaning agent as contemplated herein can be metered or introduced into the interior of the washing machine or dishwasher manually, or alternatively the detergent/cleaning agent can be dosed into the interior of the washing machine or dishwasher by employing the dosing chamber.

In various embodiments the methods described above are exemplified in that the protease is used at a temperature of from about 0 to about 100° C., preferably from about 0 to about 60° C., more preferably from about 20 to about 40° C., and most preferably at about 20° C.

These methods include both manual and automatic methods, wherein automatic methods are preferred. Methods for cleaning textiles are exemplified generally in that various cleaning-active substances are applied in a number of steps to the item(s) to be cleaned and are washed off after the reaction time, or in that the item(s) to be cleaned is/are treated in another way with a detergent or a solution or dilution of this detergent. The same is true for methods for cleaning all materials other than textiles, in particular hard surfaces. All conceivable washing or cleaning methods can be enhanced in at least one of the method steps by the use of a detergent or cleaning agent as contemplated herein and then constitute embodiments of the present disclosure. All substantive matter, subjects and embodiments described for detergents/cleaning agents as contemplated herein are also applicable to this subject matter of the present disclosure. Thus, express reference is made at this juncture to the disclosure at corresponding points, with the note that this disclosure is also applicable to the preceding methods as contemplated herein.

All substantive matter, subjects and embodiments described for the detergents/cleaning agents as contemplated herein is/are also applicable to this subject of the present disclosure. Thus, express reference is made at this juncture to the disclosure at corresponding points, with the note that this disclosure is also applicable to the preceding uses and methods as contemplated herein.

### EXAMPLES

### Example 1: Composition

An exemplary liquid detergent matrix (usable as phase B of the base composition (prior to enzyme addition)) is specified in the following Table 1.

| Ingredient | % by weight |
|---|---|
| Propylene glycol | 8.2 |
| Glycerol | 10.5 |
| Optical brightener | 0.6 |
| Linear alkylbenzene sulfonate | 22.0 |
| C13/15 oxoalcohol with 8 EO | 24.0 |
| Monoethanolamine for saponification | 6.0 |
| C12-18 soap | 7.5 |
| Polyethylene imine polymer | 6.0 |
| DTPMPA 7Na | 0.7 |
| Ethanol | 3.0 |
| Soil Release Polymer | 1.4 |
| Perfume | 1.7 |
| Dye | 0.01 |
| Water | 8.39 |

The formulation contains 8.39% by weight water from additions and raw materials. All ingredient specifications as active substance.

### Example 2: Storage Stability of Enzymes in Commercially Available Liquid Detergent Matrix According to Table 1

| | Remaining activity in % after |
|---|---|
| Enzyme | 4 weeks' storage at 40° C. |
| Protease (Subtilisin) | 61% |
| Amylase | 33% |
| Mannanase | 20% |

Storage data presented by way of example of detergent enzymes used conventionally. 4 weeks at 40° C. corresponds to very demanding/harsh conditions, and therefore a significant decrease in residual activity corresponds to expectations.

### Example 3: Storage Stability of Enzymes in Concentrated Formulation

| | Remaining activity in % after |
|---|---|
| Enzyme | 8 weeks' storage at 40° C. |
| Protease | 97% |
| Amylase | 90% |
| Mannanase | 81% |

If the enzyme preparations are stored in concentrated form, i.e. not incorporated in a detergent matrix, but instead are stored in the form supplied from the manufacturer, they remain very stable, even after 8 weeks of storage at 40° C.

### Example 4: Storage Stability of Metalloprotease

A commercially available subtilisin protease and a metalloprotease as contemplated herein were each stirred into a commercially available liquid detergent matrix (Table 1) at the same activity level (hydrolysis of suc-AAPF-pNA), and the starting activity and remaining activity of the proteases after 2 weeks' storage at 40° C. were measured. In order to generate harsh conditions, the proteases were stored in a detergent matrix without stabiliser (boric acid).

The activity of the protease was determined by the release of the chromophore para-nitroaniline from the substrate succinyl alanine-alanine-proline-phenylalanine-para-nitroanilide (AAPFpNA; Bachem L-1400). The release of the pNA resulted in an increase of the extinction at 410 nm, the profile of which over time is a measure for enzymatic activity. The measurement was taken at a temperature of 25° C., at pH 8.6 and a wavelength of 410 nm. The measurement time was 5 min with a measurement interval of 20 to 60 seconds.

Measurement Approach:

10 μL AAPF solution (70 mg/mL)
1000 μL tris/HCl (0.1 M; pH 8.6 with 0.1% Brij 35)
10 μL diluted protease solution
kinetics over 5 min at 25° C. (410 nm)

As expected, the metalloprotease is not stable in a detergent matrix and the enzyme activity almost completely disappeared after just 2 weeks. This did not apply to the subtilisin protease.

| | Remaining activity in % after |
|---|---|
| Enzyme | 2 weeks' storage at 40° C. |
| Subtilisin protease | 90% |
| Metalloprotease | 23% |

Summary: The metalloprotease is not suitable for use in a commercially available detergent matrix.

### Example 5: Storage Stability of Metalloprotease in Concentrated Formulation

| | Remaining activity in % after |
|---|---|
| Enzyme | 2 weeks' storage at 40° C. |
| Subtilisin protease | 100% |
| Metalloprotease | 94% |

Storage of the metalloprotease in concentrated form, outside a detergent matrix, is unproblematic. The enzyme activity was preserved almost in full, even after 2 weeks' storage at 40° C.

### Example 6: Comparison of the Washing Performance

A metalloprotease (with the amino acid sequence according to SEQ ID NO: 1) with activity identical to that of a subtilisin protease was placed in the corresponding washing liquor of the detergent matrix specified in Example 1.

Conditions: 20° C., 16° dH water, 1 h,

### Stains:

1. CFT CS-38 (egg yolk/carbon)
2. CFT C-05 (blood/milk/ink)
3. H-MR-B (milk/carbon)
4. CFT C-10 (milk/oil)
5. CFT CS-08 (grease)

Fabric cut-outs (diameter=10 mm) were placed in microtitre plates, washing liquor was controlled previously to 20° C., final concentration 4.7 g/L, liquor and enzyme were placed on the stain, and said fabrics were incubated for 1 h at 20° C. and 600 rpm. The stains were then rinsed a number of times with clear water, left to dry, and the lightness was determined using a colorimeter. The lighter the fabric was, the better was the cleaning performance. Here, the L-value=lightness was measured (the higher, the lighter). The performance on the stain in question relative to the subtilisin protease is specified in %.

| | % relative to subtilisin reference |
|---|---|
| 1 | 140 |
| 2 | 170 |
| 3 | 110 |
| 4 | 200 |
| 5 | 180 |

Summary: In the mini washing test a significantly improved washing performance of the metalloprotease compared to the subtilisin protease was observed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A detergent or cleaning agent, wherein the agent comprises two enzyme-containing compositions A and B physically separated from one another, wherein
(a) composition A is liquid and comprises at least one protease; and
(b) composition B comprises at least one enzyme different from the protease in the first enzyme-containing composition A.

2. The detergent or cleaning agent according to claim 1, wherein the enzyme-containing composition A comprises the at least one protease in an amount of active protein of from about 0.1 to about 50% by weight.

3. The detergent or cleaning agent according to claim 1, wherein the first enzyme-containing composition A comprises at least one organic solvent.

4. The detergent or cleaning agent according to claim 1, wherein the first enzyme-containing composition A does not contain any further enzymes in addition to the at least one protease.

5. The detergent or cleaning agent according to claim 1, wherein the first enzyme-containing composition A comprises at least one surfactant.

6. The detergent or cleaning agent according to claim 1, wherein the first enzyme-containing composition A comprises at least one enzyme stabiliser and/or protease inhibitor.

7. The detergent or cleaning agent according to claim 1, wherein the first enzyme-containing composition A comprises at least one metalloprotease, wherein the at least one metalloprotease is selected from metalloproteases from B. amyloliquefaciens and variants thereof.

8. The detergent or cleaning agent according to claim 1, wherein the first enzyme-containing composition A does not contain any further constituents besides the at least one protease and optionally surfactant, enzyme stabiliser, solvent, salts and/or water.

9. The detergent or cleaning agent according to claim 1, wherein the second enzyme-containing composition B comprises at least one enzyme selected from the group of proteases, amylases, lipases, cellulases, mannanases, hemicellulases, perhydrolases, oxidoreductases, and combinations thereof.

10. The detergent or cleaning agent according to claim 1, wherein the second enzyme-containing composition B comprises a protease different from that in the first enzyme-containing composition A.

11. The detergent or cleaning agent according to claim 1, wherein the second enzyme-containing composition B is liquid.

12. The detergent or cleaning agent according to claim 1, wherein the detergent or cleaning agent is present in the form of a multi-chamber pouch and the compositions A and B are located in different chambers of the multi-chamber pouch.

13. The detergent or cleaning agent according to claim 1, wherein the detergent or cleaning agent:
(a) is present in the form of a unit dose; and/or
(b) comprises at least one further composition C, which can be solid or liquid;
(c) the composition B comprises at least one further constituent selected from the group of builders or surfactants; and/or
(d) is phosphate-free.

14. The detergent or cleaning agent according to claim 1 utilized for laundering of textiles or automatic cleaning of dishes.

15. A method for laundering textiles or automatic cleaning of dishes, the method comprising the step of utilizing a detergent or cleaning agent according to claim 1.

16. The detergent or cleaning agent according to claim 1, wherein the first enzyme-containing composition A comprises at least one metalloprotease.

17. The detergent or cleaning agent according to claim 16, wherein the metalloprotease comprises an amino acid sequence having at least 80% sequence identity with the amino acid sequence specified in SEQ ID NO: 1 over the entire length.

18. The detergent or cleaning agent according to claim 3, wherein the at least one organic solvent is selected from the group of glycerol, 1,2-propanediol, sorbitol, and combinations thereof, and wherein the first enzyme-containing composition A comprises the at least one organic solvent in an amount of from about 10 to about 90% by weight in relation to the total weight of the composition.

19. The detergent or cleaning agent according to claim 5, wherein the at least one surfactant comprises an alkoxylated alcohol, and wherein the first enzyme-containing composition A comprises the at least one surfactant in an amount of from 0.01 to 5% by weight, in relation to the total weight of composition A.

20. The detergent or cleaning agent according to claim 10, wherein the second enzyme-containing composition B comprises a protease different from that in the first enzyme-containing composition A and is selected from the group of subtilisins and variants thereof.
